(19) United States
(12) Patent Application Publication
(10) Pub. No.: US 2013/0271619 A1
(43) Pub. Date: Oct. 17, 2013

(54) CONTROL DEVICE FOR A LENS OF A CAMERA

(71) Applicants: Martin Longmore, Muenchen (DE); Robert Wolff, Wurmsham (DE); Joachim Meinberg, Muenchen (DE); Wolfgang Stanek, Haar (DE)

(72) Inventors: Martin Longmore, Muenchen (DE); Robert Wolff, Wurmsham (DE); Joachim Meinberg, Muenchen (DE); Wolfgang Stanek, Haar (DE)

(21) Appl. No.: 13/504,434

(22) PCT Filed: Apr. 20, 2010
(86) PCT No.: PCT/EP10/02412

§ 371 Date: Oct. 5, 2012

(30) Foreign Application Priority Data
Oct. 27, 2009 (DE) 20 2009 014 504.2

(51) Int. Cl. H04N 5/232

(52) U.S. Cl. CPC H04N 5/232
USPC 348/211.99

(57) ABSTRACT

A control device for a lens (12) of a camera (10), in particular an HD camera, for adjusting the focus, the aperture and/or the zoom comprises at least one electric motor drive unit (16) for adjusting a lens ring (14) and at least one operating unit (18) with a manually deflectable operating element (28) for controlling the drive unit (16). The operating unit (18) has a monitoring device which provides tactile feedback about the extent and/or the direction of the manual deflection.

The invention relates to a control device for a lens of a camera, in particular an HD camera, for adjusting the image definition or focus, the aperture and/or the zoom. The invention also relates to a camera system having such a control device.

With respect to the adjustment of the focus, professional cameramen work almost exclusively in the “manual mode” of a camera, i.e., without the automatic settings, because only certain sections of an image (“close-ups”) need to be focused, not the overall image. The manual adjustment of focus is performed with the aid of an adjusting ring on the lens of the camera (focus lens ring).

It is customary in professional use to combine a so-called focus finding device with the camera lens; it is operated manually to relieve the cameraman from the need for a focus assistant (Focus Finder). The focus finding device is usually connected to the focus lens ring only mechanically. However, electric motor-operated drive units arranged on the camera lens are also known, transmitting a torque to the external teeth of the focus lens ring via a pinion, for example, for the focus adjustment. Such a drive unit is disclosed in EP 0 575 022 B1, for example.

Electromechanical focus or aperture systems are primarily used to record defined sequences using predetermined settings, in particular on a film set. As a rule, a prepared scene will be shot several times, which is why, with these systems, the emphasis is on the reproducibility of the focus or aperture settings and the lens position (focus or aperture point system) associated with this.

In private use as well as in many professional photographic situations, it would be advantageous if the user and/or the cameraman himself could perform a fast, simple and accurate focus adjustment in order to be able to respond spontaneously to a situation. However, adjusting the focus directly on the lens ring or an indirect adjustment with the aid of a focusing device or so-called “follow focus systems” always presupposes that the user and/or the cameraman must let go of the camera with one hand. This makes it impossible for the cameraman to change the focus as quickly as would be necessary for documentation and reporting, for example. Furthermore, releasing the camera with one hand, in particular in “moves,” results in shaking, which then causes an unacceptable blurring precisely during demanding takes in the extremely sensitive HD field.

The situation is similar for adjusting the iris aperture opening and the zoom (focal distance). Therefore this greatly reduces the possible applications of high quality HD cameras.

The object of the invention is to make available to the user of a camera a convenient, rapid and accurate adjustment of the focus, the aperture and/or the zoom, preferably without any negative effect in manual operation of the camera.

This object is achieved according to the present invention by a control device for a lens of a camera, in particular an HD camera, having the features of claim 1. Advantageous and expedient embodiments of the control device according to the invention are derived from the dependent claims.

The control device according to the invention for adjusting the focus, the aperture and/or the zoom comprises at least one electric motor drive unit for adjusting a lens ring and at least one operating unit having a manually deflectable operating element for controlling the drive unit. The operating unit has a monitoring device, which provides tactile feedback about the extent and/or the direction of the manual deflection.

The control device according to the invention, which is fundamentally suitable for any type of photographic, video, film and/or television camera having (interchangeable) lenses, can be used universally, unlike the known approaches. It greatly facilitates focus finding, opening of the aperture and/or the zoom on the camera lens. Because of the tactile feedback, the user has a feeling of precisely how much he is deflecting the operating element at all times. This automatic monitoring of the instantaneous deflection permits an intuitive and highly precise adjustment of the lens properties. The invention thus creates the prerequisite for a cameraman to be able to take over this task himself, even in professional film operation using a sensitive HD camera.

Since the operating unit can be designed and positioned independently of the drive unit, an arrangement of the operating element near a handhold of the camera is possible. This allows the cameraman to operate the control device using only one finger (e.g., the thumb) without having to release the respective hand from the handhold on the camera. With some practice, the operating element can be sensed easily—without turning one's eyes away from the camera—and deflected as needed and as desired. Flexibility in the arrangement of the operating unit having the operating element allows optimal ergonomic approaches for both right-handed and left-handed users.

A spring element acting on the operating element is especially suitable for providing the tactile feedback by the monitoring device. Elastic springs have the advantageous property for the intended purpose that the restoring force (spring force) is proportional to the deflection (spring path). However, a more complex and more differentiated characteristic curve for the operating element can also be achieved with the aid of the spring element.

The operating element is preferably prestressed into a defined zero position (starting position, middle position) in which it remains without any external influence (e.g., due to catch engagement, or because the operating element is force-free there in contrast with neighboring positions). Automatic zero point reset is thus ensured, so that intuitive operation is further improved. The user then knows precisely that releasing the operating element will immediately lead to stopping the drive unit. Thus, if the user has made the correct setting, he need only release the operating element briefly, and the lens ring remains in the current position.

According to the possibility of rotating the lens ring in two opposite directions, an operating element that can be deflected in two directions is advantageous for the control device according to the invention, in particular to facilitate a change in direction in a simple manner.

At least one end stop, which appropriately limits the deflection of the operating element, may also contribute toward convenient operation.

In the preferred embodiment of the invention, the monitoring device is designed so that the prestress on the operating element, pulling it into the zero position, creates a restoring force, which initially increases markedly, starting from the zero position, with an increase in the deflection of the operating element in a first range, and then increases less sharply or not at all in a second range. It has been found that such a characteristic curve having a sharper increase in the restoring force initially, which then flattens out at greater deflections (optionally ending in a final stop), is especially suitable for the desired intuitive operation.

The characteristic curve described above can be implemented in the design with a monitoring device, which has a pivot lever as well as a steering wheel connected to the operating element and has a flattened section, such that the pivot lever is forced against the flattened section with the aid of the spring element.

A first end of the pivot lever is preferably rotatably mounted on a holding section of the operating unit, and a free second end of the pivot lever opposite that is connected to one free end of the spring element.

In a preferred embodiment of the invention, the operating element is a preferably ribbed rotational wheel. It has been found that the deflection of the operating element required for the adjustment of the lens ring can be performed intuitively and with a high precision by turning a dial (depending to a certain extent on the diameter of the dial) and in particular can be performed in a very pleasant manner haptically.

Alternatively, however, the operating element may also be merely a pivot element or a rotating element in the form of sector or segment of a circle. A rocker switch or toggle switch (e.g., installed in a joystick) as the operating element is also possible, in which case the inventive tactile feedback represents a differentiation from such traditional switches without which an adjustment would be much less convenient (as is also the case with the other alternatives).

For spatial decoupling of the operating unit from the drive unit, it is advantageous to use a modular design of the control device according to the invention, in which the operating unit has a signal generating device, which generates electric signals for controlling the drive unit as a function of the manual deflection of the operating element. With this design no mechanical connection between the operating unit and the drive unit is necessary. Using electric signals for controlling the drive unit also has the advantage that the signals are generated in the signal generating device in such a way as to ensure a smooth startup of the drive, in particular of an electric motor installed in the drive unit.

Transmission of electric signals from the operating unit to the drive unit, which has been decoupled therefrom, can be accomplished in the simplest case in a hard-wired installation.

However, a (at least partial) wireless transmission of the electric signals may also be provided. This type of signal transmission allows a greater freedom of movement in more frequent replacement of or changes in the arrangement of the operating unit and/or the drive unit. Even at great distances, a wireless signal transmission is more convenient, in particular when suitable cable routing is not provided.

Especially intuitive operating of the control device according to the invention is achieved by a signal generating device, which is designed so that with an increase in the deflection of the operating element, it generates signals that induce rotation of an electric motor of the drive unit with an increase in the rotational speed. A greater deflection of the operating element thus means a more rapid adjustment of the lens ring and a lesser deflection means a slower adjustment, such as an inexperienced user without much practice would expect.

The speed and accuracy of the adjustment of the lens properties can be adapted to an electric motor used in the drive unit by means of a gear. The gear may also be integrated into the electric motor, e.g., as a downstream planetary gear.

In the preferred embodiment of the invention, the drive unit has a belt, which can be wrapped around the lens ring. A belt drive implemented in this way permits a flexible adjustment to the lens currently in use because if the belt is too short or too long, it can be replaced rapidly with a belt that fits properly.

To avoid initial idling and inaccuracies in adjustment of the lens due to tolerances in the belt, the drive unit preferably has a tension device for the belt.

Instead of the belt drive, a drive unit having a friction wheel that can be applied to the lens ring or having a gear wheel stage may also be used.

Simplified installation of the drive unit is obtained by means of a mounting device—best adapted to conventional systems—for mounting the drive unit on the camera or on the lens or on a holder provided for this purpose on the camera and/or on the lens.

According to a refinement of the invention, multiple drive units that can be controlled by a single operating unit are provided. Such a control device makes it possible to adjust several properties (focus, aperture and/or zoom) on the same lens, one after the other, using only one operating unit. For this purpose, it is necessary to switch or in some other way allocate the operating unit to one of the other drive units. However, the drive units may also be arranged on different cameras and/or lenses, so that lens properties can be adjusted on multiple cameras, optionally at the same time, using one operating unit.

The subject matter of the present invention is also a camera system having a camera and a lens as well as a control device according to the invention.

As explained previously, an arrangement of the operating unit of the control device according to the invention in the immediate proximity of a handhold for guiding the camera is especially advantageous because the cameraman can then intuitively operate the control device with only one finger, without having to release his hand from the handhold on the camera.

According to one refinement of the invention, the operating unit may also be integrally molded directly on the housing of the camera or may be integrated into the housing in the form of a reduced variant. Most cameras currently available have only one manual zoom adjustment (with autofocus). With this refinement, it is possible for the first time to also provide a manual focus and aperture adjustment in mass-produced cameras. Cameras equipped in this way then make it possible for even a layperson to record in “manual mode” and even to adjust the focus and/or the aperture, e.g., by means of the zoom operating element, which is provided anyway or by means of a separate operating element on the camera. The same thing also applies to cell phones with cameras.

However, for certain applications, an arrangement of the operating unit at a location remote from the camera may also be provided. This allows convenient operation of the control device according to the invention, which may be monitored on a monitor displaying the camera image, for example, in particular in the case of cameras positioned in inaccessible locations or moved automatically (as in sports facilities, etc.).

The present invention will now be explained in greater detail below on the basis of a preferred embodiment with reference to the accompanying drawings, in which:

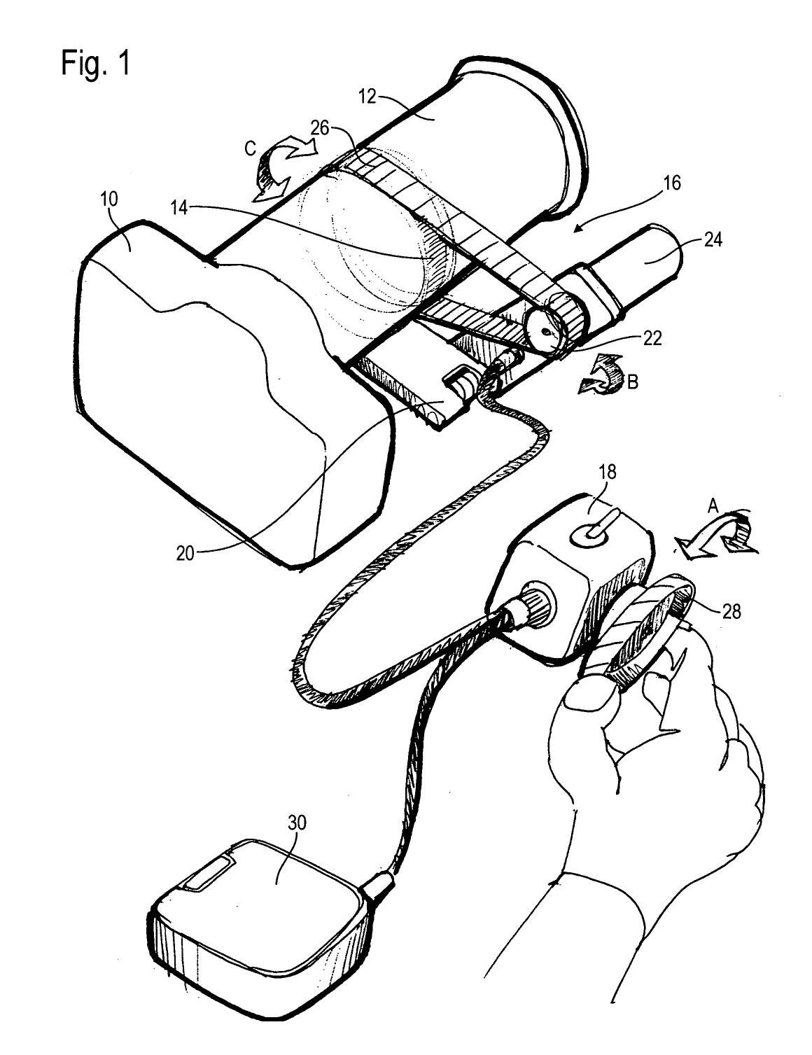

FIG. 1 shows a perspective view of a camera system having a control device according to the invention;

FIG. 2 shows a front view of the camera system;

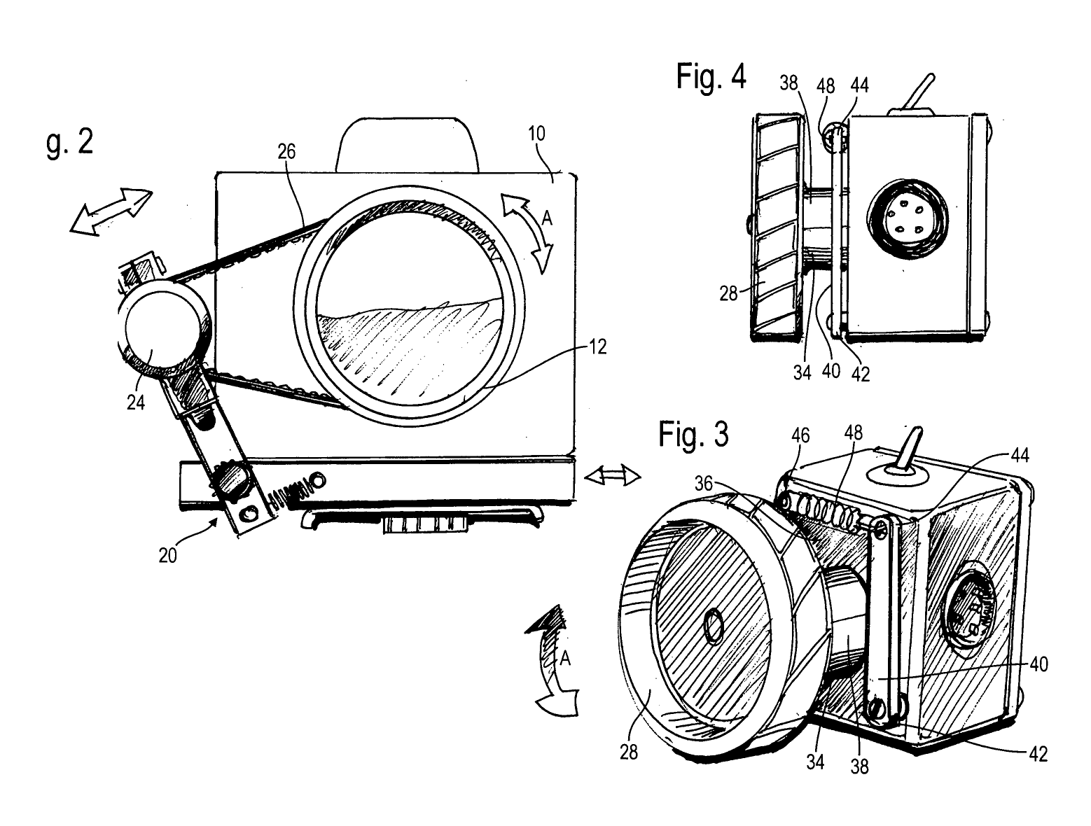

FIG. 3 shows a perspective view of the operating unit of the control device according to a first exemplary embodiment;

FIG. 4 shows a side view of the operating unit from FIG. 3;

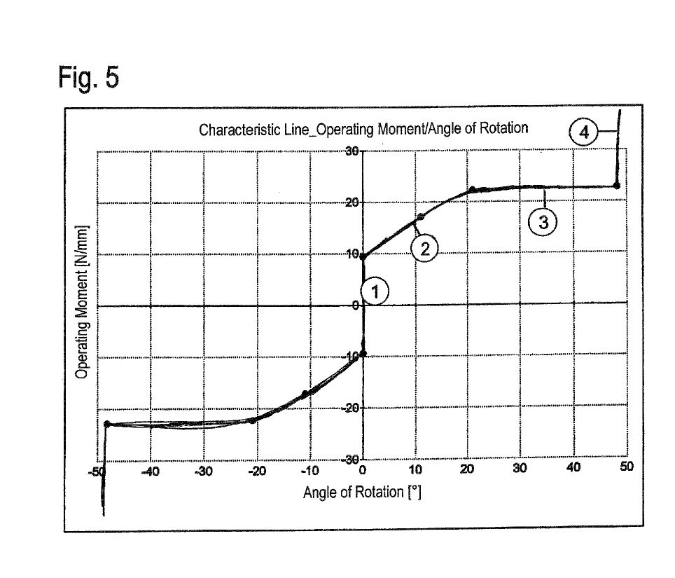

FIG. 5 shows a characteristic line diagram of the operating element having the monitoring device;

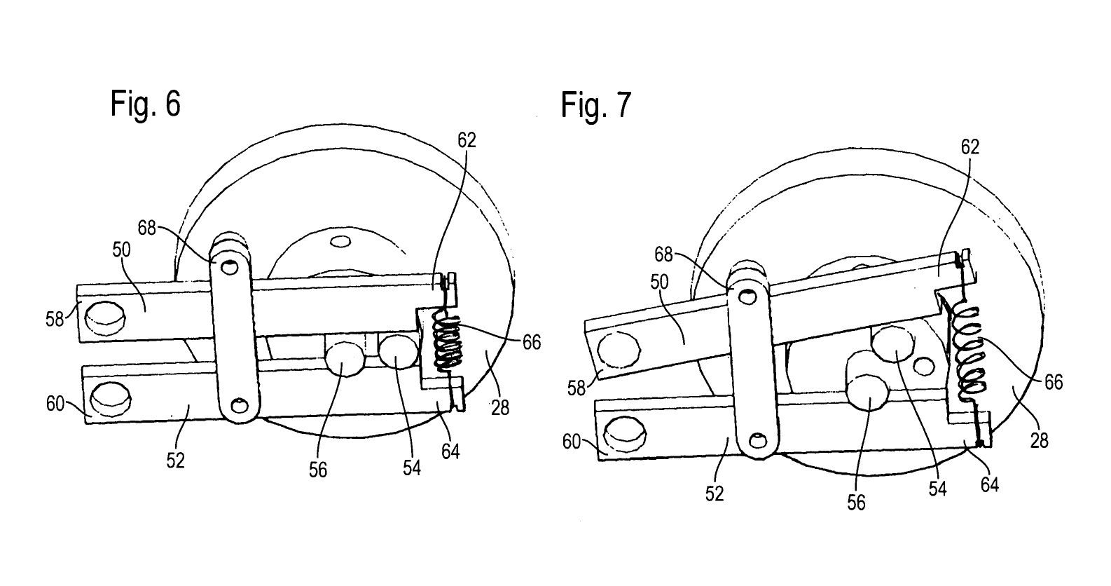

FIG. 6 shows a perspective view of a portion of the operating unit according to a second exemplary embodiment in a zero position; and

FIG. 7 shows the part of the operating unit from FIG. 6 in a deflected position.

FIGS. 1 and 2 show a camera system having a camera 10 and a lens 12 mounted on the camera. The lens 12 has adjusting rings (lens rings) 14 for manual adjustment of the focus (image definition), the iris aperture opening and the zoom (focal distance). For the sake of simplicity, of the lens rings 14, only the lens ring for adjusting the focus is shown here.

The camera system also comprises a control device, which serves to adjust the focus in the exemplary embodiment presented here, but is fundamentally also (additionally or alternatively) suitable for adjusting the aperture and/or zoom. The main components of the control device include a drive unit 16 for adjusting the lens ring 14 and an operating unit 18 for controlling the drive unit 16.

The drive unit 16 is mounted on the camera 10 or on the lens 12 with the aid of a variably adjustable mounting device 20. Likewise, a mount on a holder or on an attachment of the camera 10 and/or of the lens 12 is also possible. The drive unit 16 has a belt drive, which is linked via a drive wheel 22 to an electric motor 24 that can be driven in two directions. A downstream planetary gear having a gear ratio of approx. 1:300 is integrated into the electric motor 24. A toothed belt 26 (frictional engagement or form fitting) tailored to the surface and/or the teeth on the drive wheel 22 and the fluting of the lens ring 14 is wrapped around the drive wheel 22 on the one hand and around the lens ring 14 on the other hand.

The drive unit 16 also has a tension device (not shown in detail) for the toothed belt 26, so that the latter does not have any play. A torque is transmitted to the lens ring 14 by rotation of the electric motor 24 via (the optional gear and) the toothed belt 26, so that the lens ring is adjusted.

The operating unit 18 which is mechanically decoupled from the drive unit 16, is mounted in the immediate proximity of a handhold for guiding the camera 10. For a better overview, FIG. 1 shows the operating unit 18 in the uninstalled state. The operating unit 18 has a manually deflectable operating element 28, which is linked to an electronic signal generating device accommodated in the operating unit 18.

The signal generating device generates electric signals (pulse width modulated) as a function of the manual deflection of the operating element 28 for controlling the drive unit 16 or more specifically the electric motor 24. The signal generating unit is supplied with electricity from one or more integrated or external batteries or accumulator batteries 30 or over a power line cable with a transformer.

The operating element 28 may be deflected in two directions (see arrow A) starting from a zero position up to an end stop in each case. The deflection of the operating element 28 in two possible directions is converted accordingly by the signal generating device into control of the electric motor 24 in two directions of rotation (see arrow B). The operating unit 18 thus allows a reversal of direction in adjustment of the lens ring 14 (see arrow C).

The operating unit 18 also allows a variable speed in adjusting the lens ring 14. The signal generating device is therefore designed so that, at a small deflection of the operating element 28, it generates signals which cause a relatively slow rotation of the electric motor 24. Conversely, the signal generating device ensures that at a marked deflection of the operating element 28, the electric motor 24 is rotating relatively rapidly. It is thus possible to ensure that an increasing deflection of the operating element 28 causes an increase in the rotational speed of the electric motor 24 and a decreasing deflection causes a reduction in the rotational speed. Depending on the functionality of the signal generating device used, the adjustment rate can be varied continuously or in increments.

The electric control signals can be transmitted from the operating unit 18 to the drive unit 16 either in a hard-wired installation or wirelessly (for at least some segments), such that it is possible to rely on proven transmission techniques in the latter case.

FIGS. 3 and 4 show a particular feature of the control device, more specifically the operating unit 18: a monitoring device, which provides tactile feedback about the extent and/or direction of the manual deflection of the operating element 28. The monitoring device should first be explained in general with regard to the function and the influence on the operation of the control device, before then discussing the details of the design of the concrete exemplary embodiments shown in the figures.

The monitoring device of the operating unit 18 prestresses the operating element 28 into a defined zero position, in which no rotation of the electric motor 24 is induced. A spring element 32 acts on the operating element 28 so that a deflection of the operating element 28 generates a restoring force in the direction of the zero position.

FIG. 5 shows an optimized characteristic curve of the operating element 28 achieved with the aid of the monitoring device. The x axis shows the deflection (the angle of rotation here) of the operating element 28, while the y axis shows the respective restoring force, which corresponds to the operating moment to be applied by the user. The characteristic line is in point symmetry with respect to the zero position (1), which is why only one branch of the characteristic line will be explained. For the other branch, which represents the deflection in the opposite direction, the same thing applies accordingly.

In the area (2), which corresponds to a low rate of adjustment, the gradient of the operating moment increases toward the zero position (1). The exact adjustment should therefore be made easy for the user in the area of the image definition point (fine range). The inclination is greater in the range (3), which corresponds to a higher rate of adjustment. If the gradient is too steep in this area, this would lead to an excessively great operating force, which would in turn reduce the tactile feedback in the area (2) (no differentiation from the fine range). The area (4) corresponds to the end stop of the operating element 28.

In a simpler variant of the monitoring device, the restoring force can also be essentially proportional to the deflection of the spring element 32 in accordance with a conventional spring characteristic.

The user, whether holding or moving the operating element 28, feels the restoring force and can infer the extent and direction of the instantaneous deflection of the operating element 28 directly from the size and direction of the restoring force. There is thus a functional relationship between the rate and direction of adjustment on the one hand and the operating force that must he applied by the user to overcome the corresponding restoring force on the operating element 28 on the other hand.

In the exemplary embodiment shown in FIGS. 3 and 4, the operating element 28 is a ribbed dial, which is mounted to rotate about its central axis. A steering wheel 34 having a smaller diameter is coupled to the dial in a rotationally fixed manner, the steering wheel being arranged concentrically with the dial between the latter and a retaining section 36 (outside wall of the housing) of the operating unit 18. The steering wheel 34 has a flattened section 38 on the outside. The flattened section 38 is essentially planar and imparts a shape to the steering wheel 34, such as that which would occur by removing a segment of a circle from a disk.

A central section of a pivot lever 40 is in contact with the flattened section 38 of the steering wheel 34. A first end 42 of the pivot lever 40 is rotatably mounted on the retaining section 36, while the opposite second end 44 is free. The spring element 32 here is an elastic helical spring, whose first end 46 is attached to the retaining section 36, while its second end 48 is connected to the second end 44 of the pivot lever 40.

The arrangement of the pivot lever 40 and the spring element 32 is selected so that the pivot lever 40 is drawn onto the flattened section 38 of the steering wheel 34. This stable position of the steering wheel 34 (and thus also of the operating element 28 which is rotationally connected thereto) corresponds to the zero position of the operating element 28. Rotation of the dial in one direction causes a deflection of the second end 44 of pivot lever 40 against the resistance of a spring element 32. The same thing is also true of rotation in the other direction.

The special arrangement and coupling of the spring element 32 and of the pivot lever 40 as well as the special shape of the steering wheel 34 and its interaction with the pivot lever 40 result in a characteristic curve like that shown in FIG. 5. The shape of the characteristic curve can be adjusted as desired by varying certain parameters such as the diameter of the steering wheel 34, the length of the flattened section 38, the spring constant of the spring clement 32, etc.

FIGS. 6 and 7 show the monitoring device of the operating unit 18 according to another exemplary embodiment from the standpoint of the retaining section 36. The function of the monitoring device in particular with respect to the tactile feedback about the extent and/or direction of the manual deflection of the operating element 28 is the same as that in the exemplary embodiment already described above in detail, but the technical implementation deviates slightly.

Unlike the exemplary embodiment with a steering wheel and a pivot lever, as shown in FIGS. 3 and 4, a design having two rockers 50, 52 and a deflection element 54 is provided here. The operating element 28 in the form of a dial is supported centrally and in a rotationally fixed manner on the shaft 56 of a rotating potentiometer (not shown). The rotating potentiometer determines the input signal for the control of direction and rotational speed of the electric motor 24. The input signal is altered by the rotation of the potentiometer based on the change in the resistance of the potentiometer associated with this.

The shaft 56 is clamped radically between the two rockers 50, 52. The two rockers 50, 52 are rotatably mounted on the retaining section 36 at a first end 58 and/or 60, so that their spacing from one another corresponds approximately to the diameter of the shaft 56. On their opposite ends 62 and/or 64, the rockers are clamped together with a spring element 66 in the form of a tension spring.

Between the two rockers 50, 52, the deflection clement 54 in the form of a pin is arranged beside the shaft 56. The deflection element 54 is fixedly connected to the operating element 28 and has a diameter corresponding approximately to that of the shaft 56.

The two rockers 50, 52 are deflectable in a plane perpendicular to the shaft 56 against the resistance of the spring element 66, such that the deflection is limited to a predetermined maximum by a connecting rod 68 in both directions, providing the end stops.

The operating element 28 is automatically secured in a zero position by the design of the monitoring device. The deflection element 54 and thus the operating element 28 are forced into the position defined as shown in FIG. 6 by the spring force transmitted by the two rockers 50, 52. In this zero position, no rotation of the electric motor 24 is caused.

FIG. 7 shows the operating element 28 and the monitoring device in counter-clockwise rotation of the operating element 28. The deflecting element 54 acts on the first rocker 50 and deflects it. The spring element 66 is stretched in this way and creates a restoring force on the operating element 28 in the direction of the zero position, said restoring force being a function of the degree of deflection. As already mentioned, the maximal deflection is limited by a stop of the rocker 50 against the connecting rod 68.

The same relationships also hold when the operating element 28 is rotated in the opposite direction of rotation (clockwise).

Different characteristic lines can be adjusted (restoring moment as a function the angle of rotation) due to the geometric design of the mechanics (e.g., the distance of the deflecting element 54 from the shaft 54 [sic; 56]) and the spring characteristic.

The importance of the monitoring device for operation of the monitoring device is understandable with the following consideration. Without the monitoring device, the user could either only guess or only monitor visually how far he has deflected the operating element 28 on the whole out of the initial zero position. In the latter case, he would have to repeatedly look back at the operating element 28 or at the lens ring 14. Apart from the fact that such visual monitoring makes sense only when the dial and/or the lens ring 14 is provided with one or more markings, looking away at all constitutes a substantial diversion of the user's attention away from operating of the camera.

The control device with the monitoring device for the operating element 28 can also be used for the status images or individual images, in particular in normal consumer or semiprofessional photographic cameras. The photographs can be focused manually with the aid of the operating element, namely in the same image section or detail which is important for the user. The same thing also applies to the adjustment of the aperture.

The operating unit 18 may be positioned in a flexible manner because of the mechanical separation from the drive unit 16. For certain applications, it may expedient not to arrange the operating unit 18 on the camera 10 or on the lens 12 but instead to arrange it at a location remote from the camera 10 to thereby create the possibility of remote control.

Through minor additional measures, a single operating unit 18, which may be arranged on one or more cameras/lenses 10, 12, may also be utilized for multiple drive units 16. In this case, several connections (optionally selectable) between the operating unit 18 and the drive units 16 must be provided for transmission of the electric signals.

Preferred embodiments with a few possible modifications have been described. However, additional variations in the design are also possible within the scope of the invention, in particular according to the aforementioned general portion of the description, although they are not depicted explicitly in the drawings.

### LIST OF REFERENCE NUMERALS

### 10 Camera

### 12 Lens

14 Lens ring
16 Drive unit
18 Operating unit
20 Mounting device
22 Drive wheel
24 Electric motor
26 Toothed belt
28 Operating element

### 30 Batteries

32 Spring element
34 Steering wheel
36 Retaining section
38 Flattened section
40 Pivot lever
42 First end of the pivot lever
44 Second end of the pivot lever
46 First end of the spring element
48 Second end of the spring element
50 First rocker
52 Second rocker
54 Deflection element

### 56 Shaft

58 First end of the first rocker
60 First end of the second rocker
62 Second end of the first rocker
64 Second end of the second rocker
66 Spring element
68 Connecting rod

1-26. (canceled)

27. A control device for a lens of a camera, in particular an HD camera for adjusting the focus, the aperture and/or the zoom, having
at least one electric motor drive unit for adjusting a lens ring, and
at least one operating unit having a manually deflectable operating element for controlling the drive unit,
wherein the operating unit has a monitoring device which provides tactile feedback about the extent and/or direction of the manual deflection in the form of a restoring force, which is perceptible with respect to direction and size for the user holding or moving the operating element.

28. The control device according to claim 27, wherein the monitoring device has a spring element acting on the operating element.

29. The control device according to claim 27, wherein the operating element is prestressed into A defined zero position.

30. The control device according to claim 29, wherein the operating element can be deflected in two directions starting from the zero position.

31. The control device according to claim 29, wherein at least one end stop is provided, limiting the deflection of the operating element.

32. The control device according to any one of claim 29, wherein the monitoring device is designed so that the prestress of the operating element into the zero position generates a restoring force, which first increases greatly with an increase in the deflection of the operating element in a first range, starting from the zero position, and then increases less strongly or not at all in a second range.

33. The control device according to any one of claim 30, wherein the monitoring device is designed so that the prestress of the operating element into the zero position generates a restoring force, which first increases greatly with an increase in the deflection of the operating element in a first range, starting from the zero position, and then increases less strongly or not at all in a second range.

34. The control device according to any one of claim 31, wherein the monitoring device is designed so that the prestress of the operating element into the zero position generates a restoring force, which first increases greatly with an increase in the deflection of the operating element in a first range, starting from the zero position, and then increases less strongly or not at all in a second range.

35. The control device according claim 27, wherein the control device has a pivot lever as well as a steering wheel that has a flattened section and is connected to the operating element such that the pivot lever is pressed against the flattened section with the aid of the spring element.

36. The control device according to claim 35, wherein a first end of the pivot lever is rotatably mounted on a retaining section of the operating unit and an opposite free second end of the pivot lever is connected a free end of the spring element.

37. The control device according to claim 27, wherein the operating element is rotationally fixedly mounted on a shaft and has a deflecting element arranged next to the shaft.

38. The control device according to claim 37, wherein the shaft and/or the deflecting element is/are clamped between two rockers which are rotatably mounted in particular in a plane perpendicular to the shaft and/or pressed together with a spring element on one end.

39. The control device according to claim 38, wherein the rotation of the rockers is limited by a connecting rod.

40. The control device according to claim 27, wherein the operating element is a ribbed dial.

41. The control device according to claim 27, wherein the operating unit has a signal generating device which generates electric signals for controlling the drive unit as a function of the manual deflection of the operating element.

42. The control device according to claim 41, wherein a hard-wired transmission of the electric signals is provided.

43. The control device according to claim 41, wherein a wireless transmission of the electric signals is provided.

44. The control device according to claim 41, wherein the signal generating device is designed so that with an increase in the deflection of the operating element it generates signals which induce a rotation of the electric motor of the drive unit with an increase in the rotational speed.

45. The control device according to claim 27, wherein the drive unit has a geared motor.

46. The control device according to claim 27, wherein the drive unit has a belt which can be wrapped around the lens ring.

47. The control device according to claim 46, wherein the drive unit has a tension device for the belt.

48. The control device according to claim 27, wherein the drive unit has a friction wheel or a gear wheel stage that can be applied to the lens ring.

49. The control device according to claim 27, further comprising a mounting device for attaching the drive unit to the camera or to the lens or to a holder provided on the camera and/or on the lens.

50. The control device according to claim 27, wherein multiple drive units are provided, these drive units being connectable via a single operating unit.

51. A camera system having a camera, a lens and a control device as claimed in claim 27.

52. The camera system according to claim 51, wherein the operating unit is arranged in immediate proximity to a handhold for guiding the camera.

53. The camera system according to claim 51, wherein the operating unit is attached directly to the housing of the camera or is integrated into the housing.

54. The camera system according to claim 51, wherein the operating unit is arranged at a site at a distance from the camera.
